(19) United States
(12) Patent Application Publication
(10) Pub. No.: US 2026/0087654 A1
(43) Pub. Date: Mar. 26, 2026

(54) SYSTEM AND METHOD FOR PREDICTING CENSUS DATA USING SATELLITE IMAGES

(71) Applicant: College of William & Mary, Williamsburg, VA (US)

(72) Inventors: Daniel Miller Runfola, Williamsburg, VA (US); Heather Baier, Williamsburg, VA (US); Anthony Stefanidis, Williamsburg, VA (US)

(73) Assignee: College of William & Mary, Williamsburg, VA (US)

(21) Appl. No.: 18/897,114

(22) Filed: Sep. 26, 2024

(51) Int. Cl. G06T 7/33; G06T 7/62; G06V 20/13

(52) U.S. Cl. CPC G06T 7/33; G06T 7/62; G06V 20/13; G06T 2207/10032; G06T 2207/20084

(57) ABSTRACT

A satellite image of a geographic region is cropped. Each pixel of the cropped satellite image is brightened. A first portion of the brightened satellite image is sampled and has a centroid defined by a geographic location. A second portion of the brightened satellite image centered on the centroid is generated. The first and second portions have different resolutions. The first and second portions are processed to generate respective first and second outputs where each output is indicative of features therein. The first and second outputs are processed to generate an estimated census metric associated with the centroid. The estimated census metric is compared with a corresponding metric from collected census data to generate a difference therebetween. The location of the centroid is moved to a revised location and the process is repeated until the difference is less than a prescribed threshold.

### STATEMENT REGARDING FEDERALLY SPONSORED RESEARCH AND DEVELOPMENT

This invention was made with government support under Grant No. 17STQAC00001-04-00 awarded by the Department of Homeland Security. The government has certain rights in the invention.

### FIELD OF INVENTION

The field of the invention relates generally to the processing of satellite image data, and more particularly to a system and method for predicting various census data metrics using satellite images of large geographic areas that also present extreme scope variance.

### BACKGROUND OF THE INVENTION

The lack of systematically collected census data in developing nations inhibits an understanding of human well-being and concomitant vulnerabilities. This lack of information limits the ability of sociologists, economists, climatologists, governments, etc., to understand or observe the evolution of social processes, effectively allocate resources and/or interventions to improve human conditions, and to measure the effectiveness of such resources/interventions. In response to this gap, a number of practitioners and scholars are considering how to utilize more-regularly collected information from satellite sources by focusing on the use of deep learning to estimate socioeconomic information. While some of these techniques have shown considerable promise as a way to fill the gaps in socioeconomic data across a growing set of domains, deep learning models still face limitations when applied to satellite information to estimate socioeconomic outcomes due to the problems associated with estimating variables collected across large geographic areas (aka ‘large area estimation’) and concomitant concerns about extreme scope variance. Specifically, geographic regions to which socioeconomic data is most commonly aggregated are not uniform in nature. For example, in Mexico, the size of regions of interest can range from 2.21 km² (i.e., satellite images will have approximately 74,000 30-meter pixels) to 72,417.9 km² (i.e., satellite images will have millions of 30-meter pixels).

### BRIEF SUMMARY OF THE INVENTION

Accordingly, it is an object of the present invention to provide a system and method for the prediction of various census data metrics using satellite images of large geographic areas that also present extreme scope variance.

In accordance with an embodiment of the present invention, a method is provided for implementation by an interactive neural network inclusive of a first network trained with ImageNet, a second network comprising a recurrent neural network, and a third network trained with census data collected for a geographic region. A satellite image of the geographic region is obtained and then cropped by a processor coupled to the interactive neural network to define a cropped satellite image inclusive of a selected region of the geographic region wherein each pixel of the cropped satellite image has a brightness value. The brightness value for each pixel in the cropped satellite image is increased by the processor to generate a brightened satellite image. The processor samples a first portion of the brightened satellite image wherein the first portion has a centroid defined by a location in the selected region. The processor generates a second portion of the brightened satellite image centered on the centroid wherein the first portion and the second portion have different resolutions. The first network processes the first portion to generate a first output indicative of features in the first portion and the second portion to generate a second output indicative of features in the second portion. The second network and third network process the first output and the second output to generate an estimated census metric associated with the centroid. The second network compares the estimated census metric with a corresponding metric from the census data to generate a difference therebetween. The second network moves the location of the centroid to a revised location in the selected region and repeats the sampling through comparing steps until the difference is less than a prescribed threshold.

### BRIEF DESCRIPTION OF THE DRAWINGS

The summary above, and the following detailed description, will be better understood in view of the drawings that depict details of preferred embodiments.

FIG. 1 is a schematic view of an embodiment of a system for use in implementing the method of predicting census data using satellite images in accordance with an embodiment of the present invention;

FIG. 2 is a flow diagram of a method of predicting census data using satellite images in accordance with an embodiment of the present invention;

FIG. 3 is a schematic view of a geographic region illustrating a selected region and a cropping window in accordance with an embodiment of the present invention;

FIG. 4 is an isolated schematic view of the selected region bounded by the cropping window and two common-centroid images within the selected region with each image having a different resolution in accordance with an embodiment of the present invention; and

FIG. 5 is a schematic view of a recurrent neural network having linear memory in accordance with an embodiment of the present invention.

### DETAILED DESCRIPTION OF THE INVENTION

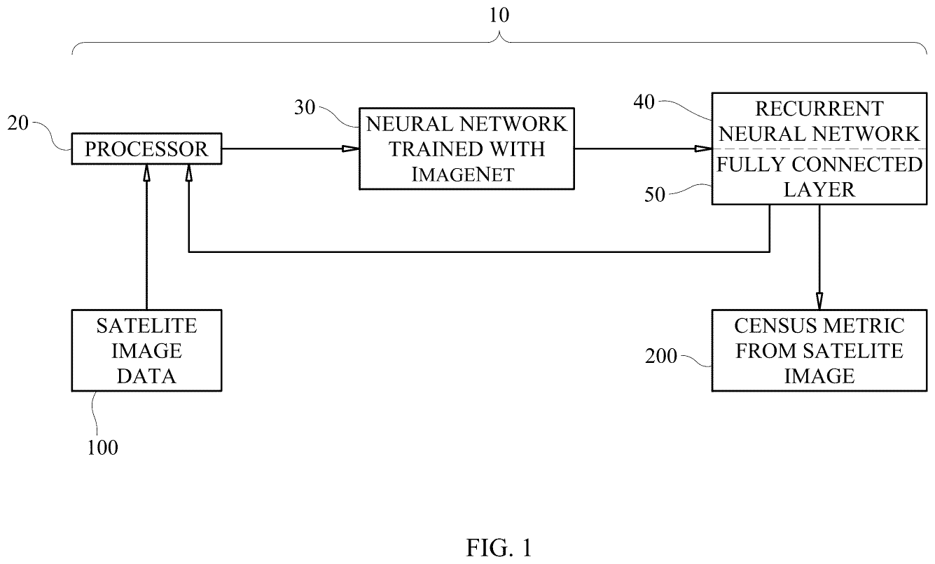

Referring now to the drawings and more particularly to FIG. 1, an embodiment of a system for use in implementing the method of predicting census data using satellite images in accordance with the present invention is shown and is referenced generally by numeral 10. In general, system 10 accesses or obtains satellite image data 100 (e.g., Landsat image data) and then processes the satellite image data to predict one or more census metrics 200. In the illustrated example, the elements of system 10 are delineated to aid in a description of the method disclosed herein. However, it is to be understood that system 10 may be realized by a variety of processing schemes without departing from the scope of the present invention.

In the illustrated example, system 10 includes a processor 20 coupled to an interactive neural network that includes a neural network 30 trained with ImageNet and a recurrent neural network 40 that includes or is coupled to a fully connected layer 50. Processor 20 may be a conventional processor programmed to select and pass portions of satellite image data 100 to neural network 30 in accordance with the method disclosed herein. Neural network 30 may be a convolutional neural network (e.g., resNet18 or resNet50 available from The MathWorks, Inc.) trained on images from the publicly available ImageNet database. As will be explained further below, neural network 30 trained with the ImageNet database is used to identify features in selected regions of the satellite image data 100. As will also be described further below, recurrent neural network 40 is a recurrent linear layer with memory whose output is passed to fully connected layer 50 trained with actual census data (e.g., census data collected by a governing body for a land area that is associated the satellite image data 100 being processed). When there is not an acceptable coincidence at fully connected layer 50, system 10 is programmed to have processor 20 select/pass different portions of satellite image data 100 to neural network 30. However, when there is acceptable coincidence at fully connected layer 50, census metric 200 is identified and a backpropagation process may be used to update parameters in neural networks 30, 40 and 50.

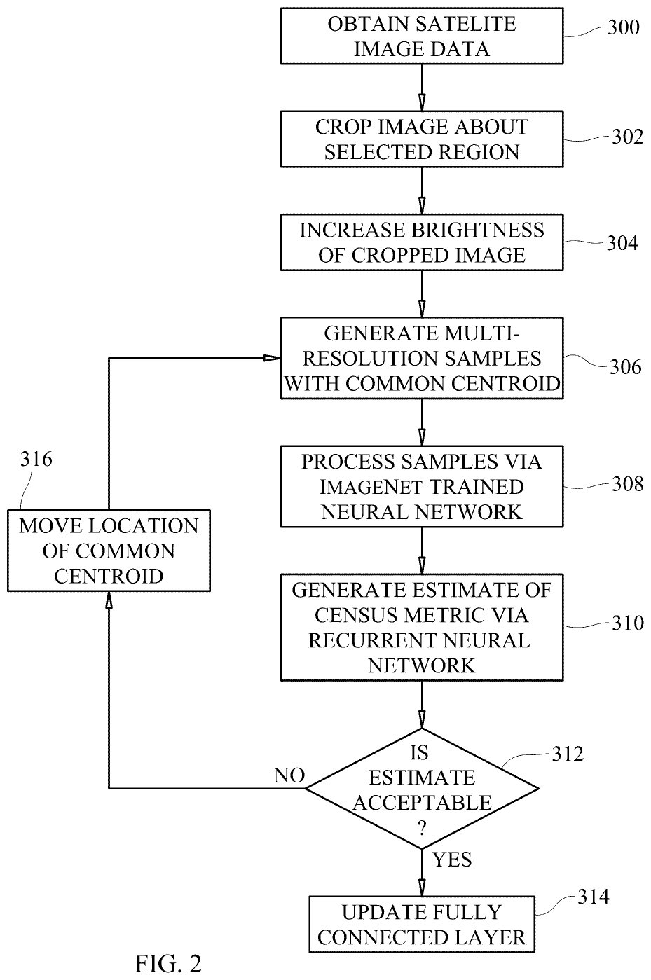

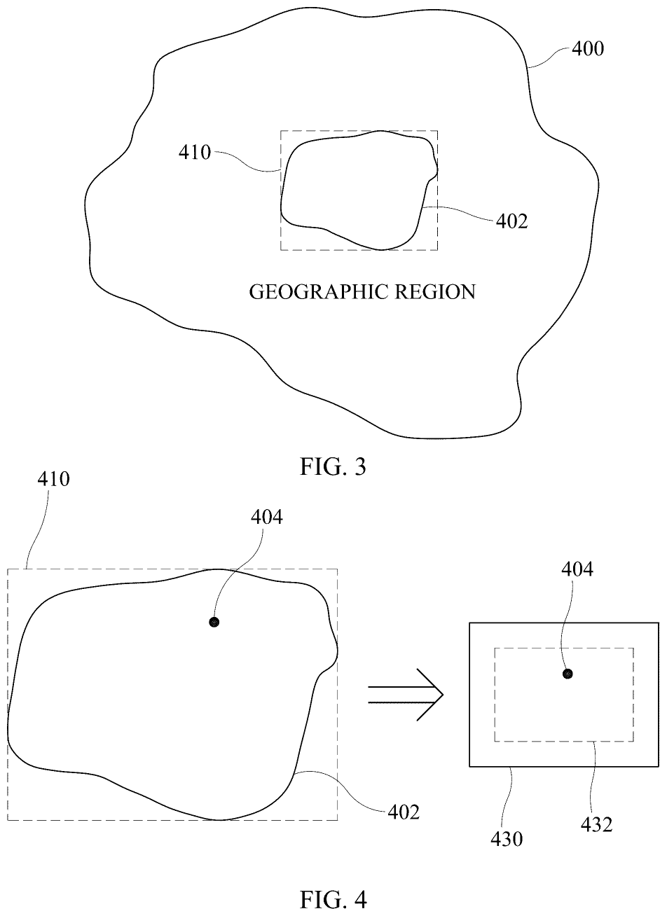

Referring additionally now to FIG. 2, a top-level flow diagram is illustrated of an embodiment of the method of the present invention. The steps presented in FIG. 2 may be accomplished using the above-described system 10. Some of the process steps in FIG. 2 are presented pictorially in FIGS. 3-4 to aid in an understanding of the present invention.

The method of the present invention commences with step 300 where the above-described satellite image data is accessed or obtained. It is assumed herein that satellite image data 100 is associated with a bounded geographic region 400 (FIG. 3) such as a country. Typically, geographic region 400 has a governing body associated therewith where such governing body implements some sort of census data collection with the collected census data being available for later use in the present invention. Geographic region 400 includes multiple region portions (e.g., region portion 402 illustrated in FIG. 3) where each such region portion 402 comprises a contiguous region made up of one or more of states, provinces, cities, counties, municipalities, or combinations thereof.

At step 302, the satellite image data associated with region portion 402 is essentially cropped by selecting the satellite image data falling within the smallest bounding box 410 that circumscribes region portion 402. Step 302 may be implemented by, for example, processor 20. While bounding box 410 may generally be thought of as being rectangular, it is to be understood that the projected space within bounding box 410 may be bent or shaped depending on the size of region portion 402, i.e., the bending increases with increasing sizes of region portion 402.

Next, at step 304, the recorded magnitudes of the satellite image data falling within bounding box 410 are increased to increase the brightness of the satellite image data. Since satellite image data is generally compressed in terms of its scale, step 304 is implemented to avoid vanishing gradients during processing of the satellite image data in accordance with the approach that will be described further below. In some embodiments, the magnitudes of each pixel of the satellite image data falling within bounding box 410 are increased (e.g., multiplied) by a factor of at least 2. Processor 20 may be used to carry out step 304.

The brightened satellite image (data) generated at step 304 is input to a repetitive or iterative process used to predict or estimate census metrics. The repetitive process commences at step 306 where multiple samples (e.g., two) of the brightened satellite image data associated with region portion 402 are generated. More specifically and with reference to FIG. 4, a location 404 (e.g., defined by a latitude and longitude pair) within region portion 402 is selected as a starting point. Two images 430 and 432 are clipped from the above-described brightened satellite image data. Images 430 and 432 have different resolutions (i.e., image 432 is smaller than image 430). However, both images 430 and 432 share a common centroid that may be location 404. In some embodiments, smaller image 432 is clipped and then image 430 is generated by zooming out from image 432. In some embodiments, image 430 is clipped and image 432 is generated by zooming in on image 430. In some embodiments, clipped image 432 is 50-80% smaller than image 430. In some embodiments, clipped image 432 is approximately 75% smaller than clipped image 430. Processor 20 may be used to implement step 306.

Next, the image data associated with clipped images 430 and 432 is provided to neural network 30 trained with ImageNet. At step 308, neural network 30 generates one output based on clipped image 430 and another output based on clipped image 432. Each such output is indicative of features (e.g., water, roads, buildings, forests, etc.) present in the corresponding clipped images 430 and 432. The two outputs generated by neural network 30 are passed to recurrent neural network 40.

Recurrent neural network 40 in combination with fully connected layer 50 generates a census metric prediction or estimation for location 404, i.e., for the latitude-longitude pair identifying location 404. In general, recurrent neural network 40 carries out a repetitive process, while fully connected layer 50 trained with collected/actual census data processes each output from the repetitive process to generate a census metric prediction/estimate that is either acceptable or unacceptable based on a prescribed threshold criteria. For example, each prediction/estimate may be compared with an actual census metric at step 312 to see if the estimate is within an acceptable prescribed error threshold. If this estimate is acceptable, the estimate is presented as a prediction and may be used to update or back-propagate fully connected layer 50 at step 314. If the estimate is unacceptable, step 316 is implemented to move location 404 by some amount/distance within region portion 402. The new position of location 404 (e.g., a new latitude-longitude pair) serves as the basis for the repetition of steps 306 to 312. In some embodiments and as will be explained further below, a Gaussian distribution function may be used to govern the amount that location 404 is moved prior to next iterative process.

By way of an illustrative example, a model architecture for implementing the above-described recurrent process will now be described. It is to be understood that this model architecture may be modified for a particular application without departing from the scope of the present invention. What follows below is a general description of the architecture's interactive neural network used in the recurrent process. For purposes of the following description, it is assumed that the above-described region portion 402 is a municipality.

As is known in the art, convolutional neural networks (CNNs) rely on a set of convolutional layers where each convolutional layer has a defined filter which is used in the convolutional process to produce features (generally represented as tensors) representative of elements of importance within an image being processed by the CNN. To formally define a CNN for the purposes of describing how the above-described multiple clipped-image (where each set of multiple images is simply referred to hereinafter as a “glimpse”) model is implemented, first let X={X_{w,h,c,i=1}, . . . , X_{w,h,c,i=n}} represent a set of n input images with width w, height h, and channels c. Additionally, let Fₗ={F_{k,k,c,j=1}, . . . , F_{k,k,c,j=f}}, where F is a set of filters to be used in the convolutional process within layer l, k are the filter dimensions, c is the channels to which a filter will be applied, j is the index of the filter, and f is the total number of filters. Weights for each filter, for each convolutional layer, are defined in W_{j,l}, with index j and l representing the filter and layer, respectively. Following this, the output of any given layer can thus be obtained by:

$${Y}_{j , l} = Xi ⊕ {W}_{j , l}$$

In most contexts, filter dimensions F/become iteratively smaller as layer/increases, at which point an affine (i.e., fully connected) layer is utilized to produce a final score for a given input Xᵢ. This final affine or fully connected layer most commonly takes the form of a multi-layer neural network in which all nodes are connected to all other nodes in the following layer.

The use of satellite imagery for the estimation of census information with convolutional models is challenged when there are highly variable spatial dimensions defining regions of interest. To mitigate this challenge, the model described herein incorporates a recurrent, multi-glimpse-based approach. Conceptually, this allows the model to iteratively apply convolutions to sampled, similarly-sized (i.e., in terms of w and h in the above notation) regions of each municipality, and training the model to bias samples towards regions that are most relevant (e.g., ignoring large stretches of desert, water, etc.). This multi-glimpse procedure is implemented in accordance with a number of steps summarized as follows:
(1) Within each municipality, a parameterized distribution of latitude and longitude coordinates is sampled to generate latitude-longitude pairs for each glimpse.
(2) For each glimpse, two images are clipped from the municipality-scale Landsat cloud-free mosaic based on the selected latitude and longitude, with a first image representing a coarse-scale (or zoomed-out) subset and the second image representing a zoomed-in region of the first image.
(3) For each glimpse, these images are passed into a resNet18 neural network that has been pre-trained on ImageNet.
(4) A linear layer with a memory function takes in each glimpse sequentially to produce the final estimate of a value for a municipality's census variable. Glimpse locations may then be moved throughout the image on the basis of a hidden element within this linear layer.
(5) The true values for each municipality are contrasted to the estimated aggregations, and the total difference or mean absolute error may be used in a backpropagation procedure to update the parameters across the neural network.

In step (1) of the above procedure, latitude and longitude pairs may be sampled from a parameterized Gaussian distribution in which the mean coordinates are constructed as parameters which are updated during the training process. The selection of a Gaussian distribution encourages the first samples in the training process to be biased towards the center of the image. Samples are clamped to the minimum and maximum coordinates of a given municipality (e.g., with coordinates normalized to a −1,1 range to facilitate sampling across all municipalities). This is formalized in notation as:

$${I}_{i , x} = ( {μ}_{x} , σ = 0.1 ) \\ {I}_{i , y} = ( {μ}_{y} , σ = 0.1 )$$

The parameters μₓ and μ_{y} are themselves estimated as the output of a small linear network that, takes as input, the hidden node values of the convolutional layer of the previous image, i.e., features detected in the previous glimpse. This allows for a dynamic strategy in which each glimpse is conditioned on the nature of the features detected in the previous glimpse. For example, if an urban area is in a first glimpse, the model may be configured to parameterize so as to preference moving a short or far distance away for the next glimpse contingent on what tends to perform best. This broadly allows for geographic attention to different areas within a municipality irrespective of the size of a given municipality.

Next, and in accordance with step (2), two images are generated for latitude and longitude pair with initial image dimensions being based on the size of the input municipality. The first image may be selected such that its centroid is the selected latitude and longitude. Image dimensions X and Y (in pixels) may be set in accordance with, for example, the relationship:

$$X , Y = min ( int ( min ( H , W ) / 5 ) , 50 ) )$$

where H is the height of the satellite image of the target municipality, and W is the width. A second zoomed-in image is then sampled from the same area. This second image retains the same centroid as the first but, in this example, has dimensions that are approximately 75% smaller than the first image. In practice, this approach results in the generation of larger windows of pixels for larger municipalities, while scaling to smaller windows for smaller cases. In this illustrative example, the scaling factor of “5” determines the relative size between cases.

In accordance with step (3), the two centroid-sharing images in the glimpse are then fed forward into a pre-trained resNet18 model (e.g., pre-trained with ImageNet), with the output vectors (e.g., each having a length of 256 in the illustrative example) of the final convolutional layer saved into two vectors, one for each image. The fully connected layer of the resNet18 network is removed such that the result is a 256-length feature vector associated with each input image of the glimpse (i.e., two 256-length vectors are generated, one for each scale of imagery). The two vectors (of dimensions [2,256]) are then fed into a recurrent linear layer with memory, alongside a vector of length 2 that includes the latitude and longitude information from where the images were generated.

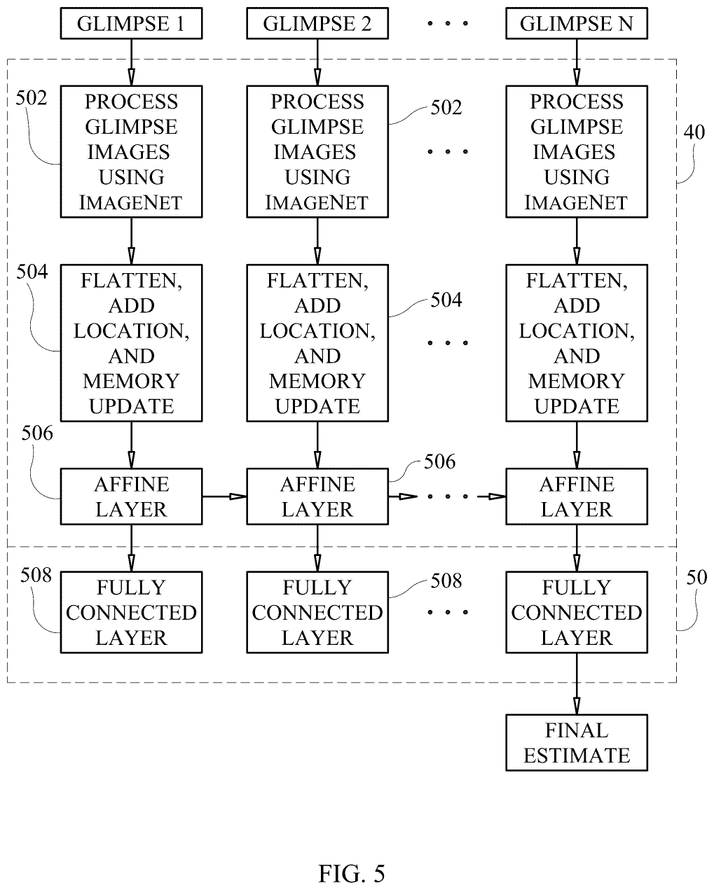

Referring now to FIG. 5, an embodiment of the recurrent linear memory implementation used in step (4) is depicted. During the first glimpse (“GLIMPSE 1”), the two (e.g., resNet18) outputs associated with the glimpse's centroid-sharing images are processed by neural network 40 at block 502. The output from block 502 is flattened at block 504 to an output size of 512 in the illustrative example. Further, the output is concatenated with the information associated with the two latitude and longitude coordinates resulting in a vector size of 514. For GLIMPSE 1, 256 “0”s are added which will be leveraged in future glimpses for memory updates. That is, the first glimpse is initialized with no memory information. As a result, a 770 element vector is generated for GLIMPSE 1 in the illustrative example.

The resulting 770 element vector is then passed into an affine layer at block 506 with an output of 256 elements which, in turn, is fed to fully connected layer at block 508 to generate the single estimate for a given value, and generate estimates for new latitude and longitude coordinates for the next glimpse. For example, new latitude/longitude coordinates may be generated by sampling from a Gaussian distribution with a standard deviation and mean parameterized as the output of the corresponding fully connected layer. Using the new latitude/longitude pair, another glimpse (e.g., “GLIMPSE 2”) is then taken, and the process is repeated. During the second glimpse as well as each subsequent glimpse, the affine layer's memory at block 506 is updated to include the previous glimpse's affine layer output from block 506. In this implementation, after N glimpses are taken, the final estimate generated at step (5) is based on all preceding steps, and may then be used to update the network parameters.

The advantages of the present invention are numerous. The multi-glimpse approach disclosed herein provides a relatively simple computational approach to using satellite imagery to predict/estimate census data metrics for large geographic regions that present with extreme scope variance. The disclosed approach to predicting/estimating socioeconomic data will be useful for a variety of professionals and government entities as they evaluate how to best allocate resources for a geographic region's future.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

We claim:

1. A method, comprising:
by an interactive neural network inclusive of a first network trained with ImageNet, a second network comprising a recurrent neural network, and a third network trained with census data collected for a geographic region,
a) obtaining a satellite image of the geographic region;
b) cropping, by a processor coupled to the interactive neural network, the satellite image to define a cropped satellite image inclusive of a selected region of the geographic region wherein each pixel of the cropped satellite image has a brightness value;
c) increasing, by the processor, the brightness value for each pixel in the cropped satellite image to generate a brightened satellite image;
d) sampling, by the processor, a first portion of the brightened satellite image wherein the first portion has a centroid defined by a location in the selected region;
e) generating, by the processor, a second portion of the brightened satellite image centered on the centroid wherein the first portion and the second portion have different resolutions;
f) processing, by the first network, the first portion to generate a first output indicative of features in the first portion and the second portion to generate a second output indicative of features in the second portion;
g) processing, by the second network and the third network, the first output and the second output to generate an estimated census metric associated with the centroid;
h) comparing, by the second network, the estimated census metric with a corresponding metric from the census data to generate a difference there between; and
i) moving, by the second network, the location of the centroid to a revised location in the selected region and repeating steps d) through h) until the difference is less than a prescribed threshold.

2. The method of claim 1, wherein the geographic region has a governing body associated therewith, and wherein the census data is collected by the governing body.

3. The method of claim 1, wherein the selected region is selected from the group consisting of at least one of a state, a province, a city, a county, and a municipality.

4. The method of claim 1, wherein the brightness value for each pixel is increased by a factor of at least 2.

5. The method of claim 1, wherein the second portion is in a range of 50% to 80% smaller than the first portion.

6. The method of claim 1, wherein the second portion is approximately 75% smaller than the first portion.

7. The method of claim 1, wherein the centroid comprises a latitude and longitude in the selected region.

8. The method of claim 1, wherein the step of moving includes applying a Gaussian distribution function to govern a distance between the location of the centroid and the revised location.

9. The method of claim 1, wherein the first output and the second output comprise vector outputs.

10. The method of claim 1, wherein the third network comprises a fully connected layer.

11. A method, comprising:
by an interactive neural network inclusive of a first network trained with ImageNet and a second network comprising a recurrent neural network inclusive of a fully connected layer trained with census data collected for a geographic region,
a) obtaining a satellite image of the geographic region;
b) cropping, by a processor coupled to the interactive neural network, the satellite image to define a cropped satellite image inclusive of a selected region of the geographic region wherein each pixel of the cropped satellite image has a brightness value;
c) multiplying, by the processor, the brightness value for each pixel in the cropped satellite image by a factor of at least 2 to generate a brightened satellite image;
d) sampling, by the processor, a first portion of the brightened satellite image wherein the first portion has a centroid defined by a location in the selected region;
e) generating, by the processor, a second portion of the brightened satellite image centered on the centroid wherein the first portion and the second portion have different resolutions;
f) processing, by the first network, the first portion to generate a first output indicative of features in the first portion and the second portion to generate a second output indicative of features in the second portion;
g) processing, by the second network, the first output and the second output to generate an estimated census metric associated with the centroid;
h) comparing, by the second network, the estimated census metric with a corresponding metric from the census data to generate a difference there between; and
i) moving, by the second network, the location of the centroid to a revised location in the selected region and repeating steps d) through h) until the difference is less than a prescribed threshold.

12. The method of claim 11, wherein the geographic region has a governing body associated therewith, and wherein the census data is collected by the governing body.

13. The method of claim 11, wherein the selected region is selected from the group consisting of at least one of a state, a province, a city, a county, and a municipality.

14. The method of claim 11, wherein the second portion is in a range of 50% to 80% smaller than the first portion.

15. The method of claim 11, wherein the second portion is approximately 75% smaller than the first portion.

16. The method of claim 11, wherein the centroid comprises a latitude and longitude in the selected region.

17. The method of claim 11, wherein the step of moving includes applying a Gaussian distribution function to govern a distance between the location of the centroid and the revised location.

18. The method of claim 11, wherein the first output and the second output comprise vector outputs.

19. A method, comprising:
by an interactive neural network inclusive of a first network trained with ImageNet and a second network comprising a recurrent neural network inclusive of a fully connected layer trained with census data collected for a geographic region,
a) obtaining a satellite image of the geographic region;
b) cropping, by a processor coupled to the interactive neural network, the satellite image to define a cropped satellite image inclusive of a selected region of the geographic region, wherein the selected region comprises at least one of a state, a province, a city, a county, and a municipality of the geographic region, and wherein each pixel of the cropped satellite image has a brightness value;
c) multiplying, by the processor, the brightness value for each pixel in the cropped satellite image by a factor of at least 2 to generate a brightened satellite image;
d) sampling, by the processor, a first portion of the brightened satellite image wherein the first portion has a centroid defined by a location in the selected region;
e) generating, by the processor, a second portion of the brightened satellite image centered on the centroid wherein the first portion and the second portion have different resolutions;
f) processing, by the first network, the first portion to generate a first output indicative of features in the first portion and the second portion to generate a second output indicative of features in the second portion;
g) processing, by the second network, the first output and the second output to generate an estimated census metric associated with the centroid;
h) comparing, by the second network, the estimated census metric with a corresponding metric from the census data to generate a difference there between; and
i) moving, by the second network, the location of the centroid to a revised location in the selected region in accordance with a Gaussian distribution function and repeating steps d) through h) until the difference is less than a prescribed threshold.

20. The method of claim 19, wherein the second portion is in a range of 50% to 80% smaller than the first portion.

21. The method of claim 19, wherein the second portion is approximately 75% smaller than the first portion.

22. The method of claim 19, wherein the centroid comprises a latitude and longitude in the selected region.

23. The method of claim 19, wherein the first output and the second output comprise vector outputs.
